(19) United States
(12) Patent Application Publication
(10) Pub. No.: US 2016/0375628 A1
(43) Pub. Date: Dec. 29, 2016

(54) METHOD FOR MAKING AN AIR PERMEABLE AND WATERPROOF TEXTILE WITH AN UNEVEN PATTERN

(71) Applicant: Swojin Enterprise Co., Ltd., Taichung (TW)

(72) Inventor: CHIEN-TAN LEE, Taichung (TW)

(21) Appl. No.: 14/751,138

(22) Filed: Jun. 26, 2015

(51) Int. Cl. B29C 59/04; D05B 27/20; B29C 65/00; B29C 59/00; D06N 7/00; B29C 65/62

(52) U.S. Cl. CPC B29C 59/046; D06N 7/00; B29C 65/62; B29C 66/45; B29C 66/729; B29C 66/73187; B29C 66/73182; B29C 59/005; D05B 27/20; B29L 2009/00

(57) ABSTRACT

A method for making an air permeable waterproof textile with an uneven pattern is disclosed. The density of the arrangement of the threading holes is high or low by controlling the transportation speed of the fabric foundation. The density of the threading holes is high while the transportation speed is high, and the density of the threading holes is low while the transportation speed is low. A vent-typed backing fabric is formed with a plurality of tiny through holes distributed densely and without removing chips. Partial or total burr portions are rolled over by the upper roller and the lower roller with the predetermined pattern so as to shield corresponding threading holes with different extent. The threading holes without shielding have total air permeability. The partially shielded threading holes have partial air permeability with different percentages. The areas of the textile without the threading holes have water proof characteristics.

### FIELD OF THE INVENTION

The present invention relates to a method for making a textile applicable for clothes or objects with water proof characteristics and air permeability, and more particularly to a method for making an air permeable waterproof textile with an uneven pattern.

### BACKGROUND OF THE INVENTION

The conventional air permeable cloth or fabric is mainly made by a waterproof film which is thin enough to be air permeable to adhere at an inner layer of a cloth body. Therefore, the waterproof film with air permeability is interposed between the top and the bottom cloth bodies with air permeability to prevent heat from permeating into the inner layer and discharge the heat outwardly to provide better clothes wearing performance.

However, because the thickness of the waterproof film is too small (that is, the waterproof is too thin), it is hard to be leveled off while in production and adhering and easy to increase the failure rate. In addition, the wearing quality is bad and it is easy to be broken or torn while being rubbed. Therefore, the waterproof film cannot be adhered on a top surface of the cloth body but adhered on a bottom surface of the cloth body or interposed between the top and the bottom surfaces (the inner layer) so that the thickness of the cloth body after adhering the waterproof film may be larger. Furthermore, the air permeability of the waterproof film may be blocked by the top and the bottom surfaces of the cloth body so that the effect of the air permeability may be influenced (worse than the original cloth body or the single waterproof film).

Accordingly, the inventor of the present invention has devoted himself based on his many years of practical experiences to solve this problem.

### SUMMARY OF THE INVENTION

The primary object of the present invention is to provide a method for making an air permeable waterproof textile with an uneven pattern. The density of the arrangement of the threading holes may be high or low by controlling the transportation speed of the fabric foundation. That is, the density of the threading holes is high while the transportation speed is high, and the density of the threading holes is low while the transportation speed is low. A vent-typed backing fabric is formed with a plurality of tiny through holes distributed densely and without removing chips. Partial or total burr portions are rolled over by the upper roller and the lower roller with the predetermined pattern so as to shield corresponding threading holes with different extent. The threading holes which are not shielded have total air permeability. The threading holes which are partially shielded have partial air permeability with different percentages. The areas of the textile without the threading holes have water proof characteristics of the waterproof film. Therefore, the textile may include air permeability, ware proof, and uneven patterns at the same time. It may be simplified materials, easy process, less material waste, cost down, and increasing yield rate.

In order to achieve the above object, the steps of the method for making an air permeable waterproof textile with an uneven pattern of the present invention may comprise:
a needle threading step: transporting a fabric foundation through a row needle set with a transportation speed toward a transporting direction, a plurality of threading holes are formed after the fabric foundation is threaded by the row needle set, the row needle set is arranged above the fabric foundation and spaced apart therefrom a distance, the fabric foundation at least includes a cloth carrier and a waterproof film made by soft plastic materials and melt adhered on a surface of the cloth carrier, the cloth carrier is arranged adjacent to the row needle set and the waterproof film is arranged opposite to the row needle set, a burr portion is extended from the waterproof film downwardly corresponding to each threading hole, and a semi-finished product is formed;
a roll-over step: transporting the semi-finished product in the transporting direction and passing between an upper roller and a lower roller arranged below the upper roller to be rolled over, and a predetermined pattern is concavely formed on a surface of the lower roller, the lower roller is heated to deform the waterproof film so that the threading holes are totally or partially shielded by corresponding burr portions with different extent and then formed water proof and air permeability with different degree, and an uneven pattern is formed on the fabric foundation corresponding to the predetermined pattern; and
a forming step: cooling the semi-finished product after the roll-over step to form an air permeable waterproof textile with the uneven pattern.

In some embodiments, another cloth carrier is melt adhered on a bottom surface of the waterproof film.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of an air permeable waterproof textile with an uneven pattern according to present invention.

FIG. 2 is a cross-sectional view of FIG. 1.

FIG. 3 is a schematic view of a method for making the air permeable waterproof textile with the uneven pattern according to present invention while in a needle threading step.

FIG. 4 is a schematic view of a method for making the air permeable waterproof textile with the uneven pattern according to present invention while rolling over.

FIG. 5 is a perspective view of a lower roller used in the method for making the air permeable waterproof textile with the uneven pattern according to present invention.

FIG. 6 is a perspective view of the air permeable waterproof textile with the uneven pattern according to present invention.

FIG. 7 is a cross-sectional view of a first embodiment of the air permeable waterproof textile with the uneven pattern according to present invention.

FIG. 8 is a cross-sectional view of a second embodiment of the air permeable waterproof textile with the uneven pattern according to present invention.

FIG. 9 is a flow chart of the method for making the air permeable waterproof textile with the uneven pattern according to present invention.

### DESCRIPTION OF THE PREFERRED EMBODIMENT

Referring now to the drawings where like characteristics and features among the various figures are denoted by like reference characters.

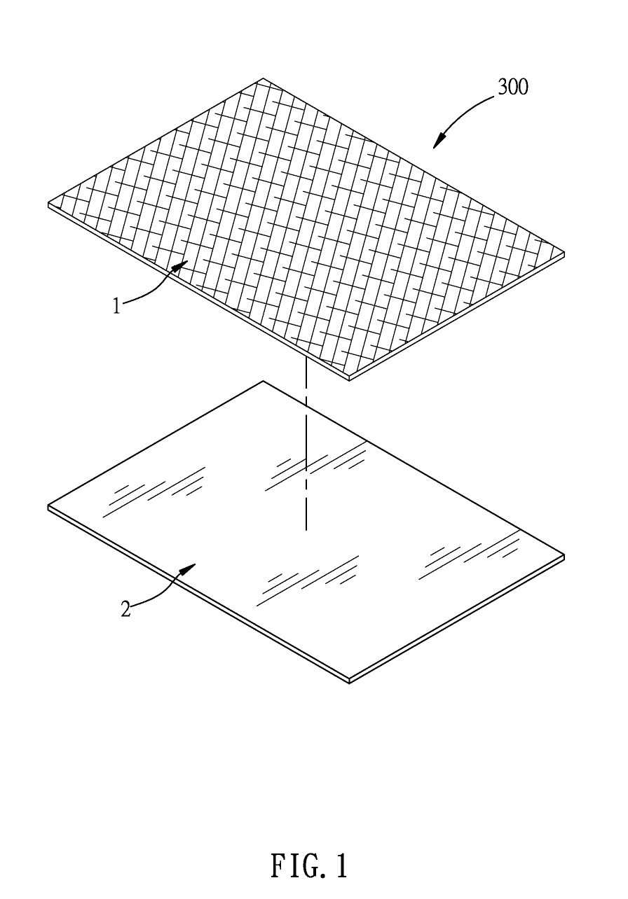

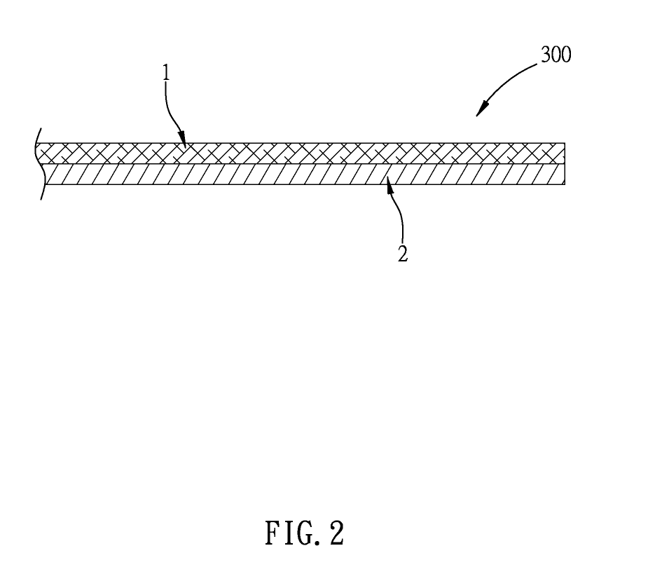

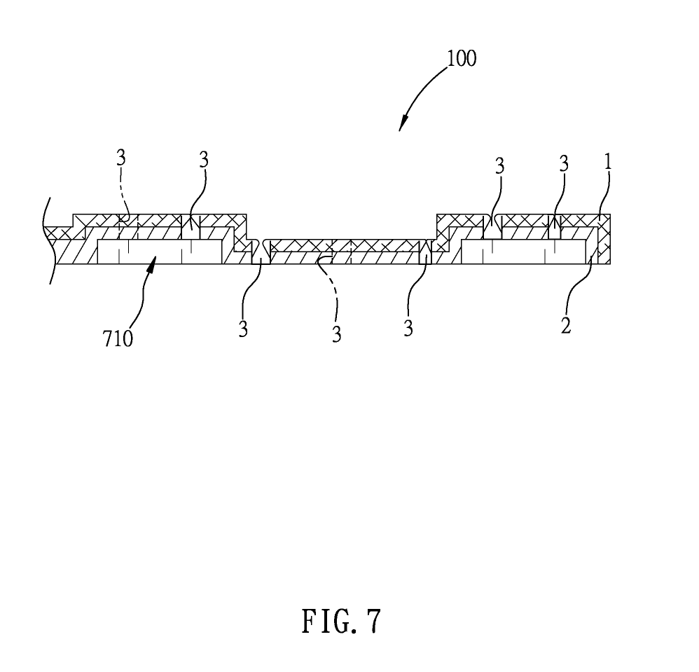

Please refer to FIGS. 1 to 3 and 7, an air permeable waterproof textile 100 with an uneven pattern of the present invention comprises a cloth carrier 1, a waterproof film 2, a plurality of threading holes 3, and a plurality of burr portions 4.

The waterproof film 2 is made by soft plastic materials and may be melt adhered on a bottom surface of the cloth carrier 1.

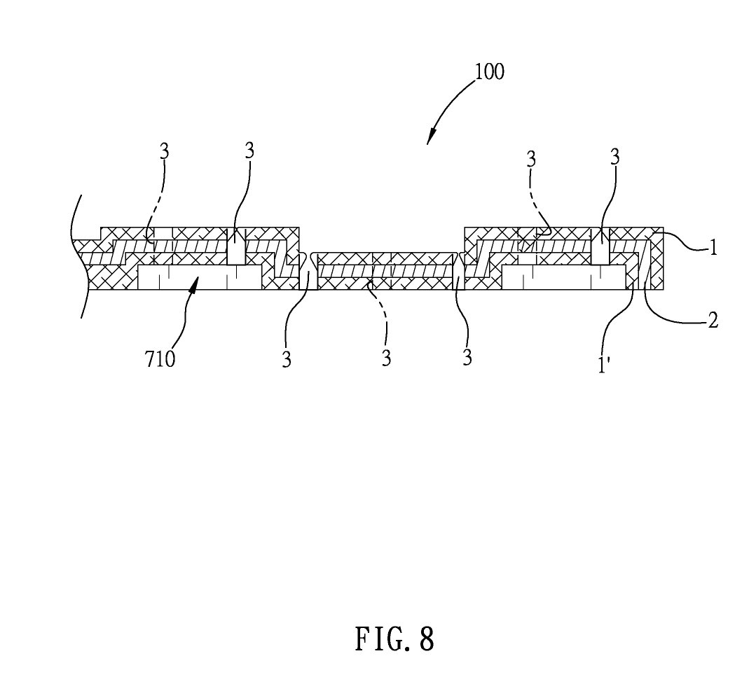

In a second embodiment shown as in FIG. 8, another cloth carrier 1′ may be further melt adhered on a bottom surface of the waterproof 2, but not limited thereto.

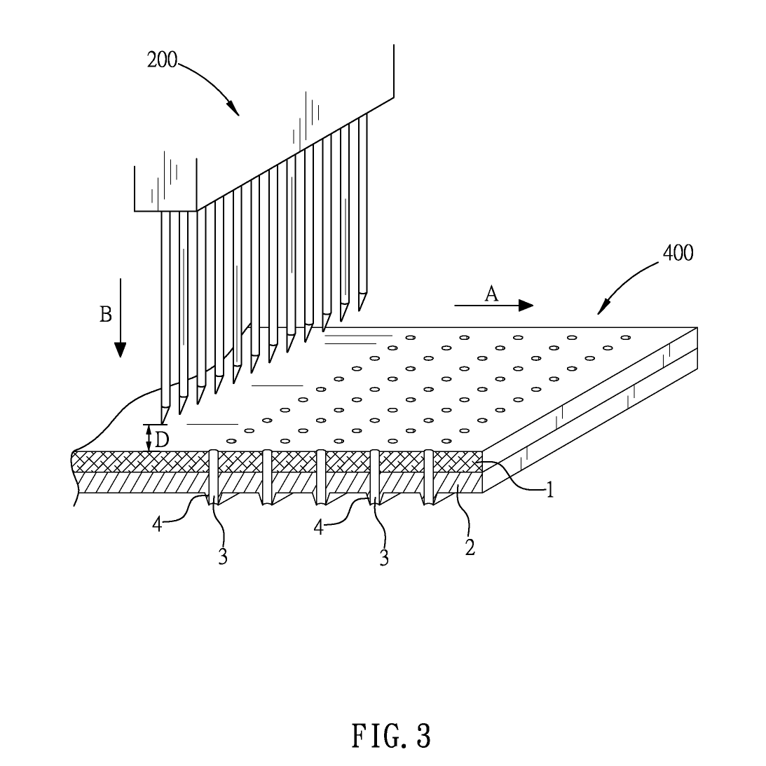

The cloth carrier 1 and the waterproof film 2 (fabric foundation 300) is transporting with a transportation speed toward a transporting direction (direction A in FIG. 3). A row needle set 200 is arranged above the cloth carrier 1 and spaced apart therefrom. The row needle set 200 may totally thread the cloth carrier 1 and the waterproof 2 to form the threading holes 3. The threading direction is from the cloth carrier 1 toward the waterproof 2 (direction B in FIG. 3). The density of the arrangement of the threading holes 3 may be high or low by controlling the transportation speed of the fabric foundation 300. That is, the density of the threading holes 3 is high while the transportation speed is high, and the density of the threading holes 3 is low while the transportation speed is low. A vent-typed backing fabric is formed with a plurality of tiny through holes distributed densely and without removing chips.

The needles of the row needle set 200 may be arranged regularly or irregularly so that the threading holes 3 may be predictably distributed regularly or irregularly to achieve the effect of changing air permeability while threading the cloth carrier 1 and the waterproof film 2.

A plurality of burr portions 4 may be formed downwardly from the waterproof 2 corresponding to the threading holes 3 after threading the waterproof film 2 with the row needle set 200.

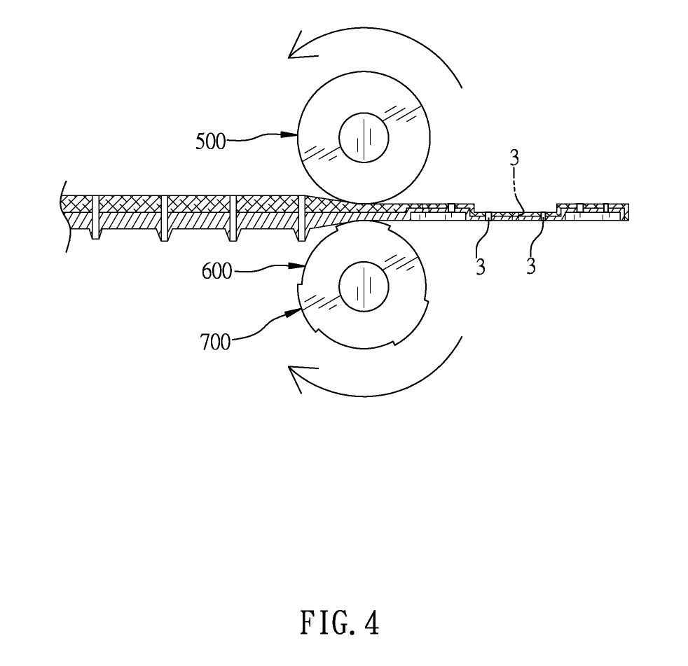

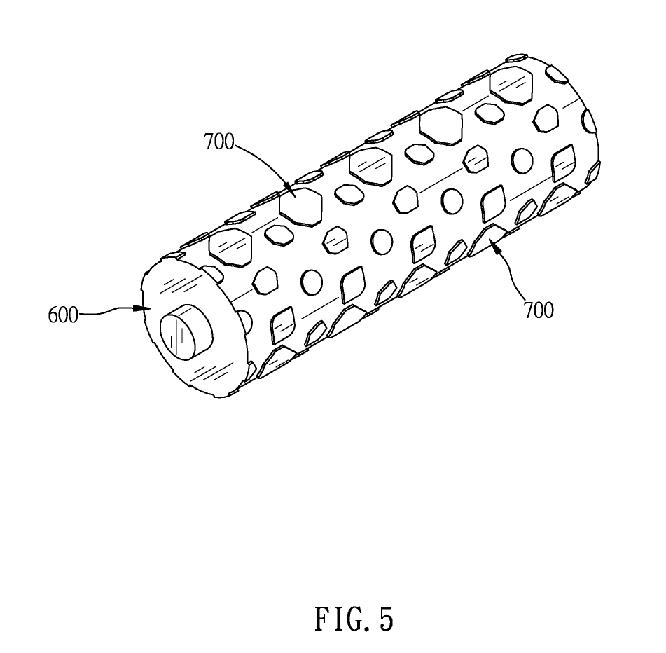

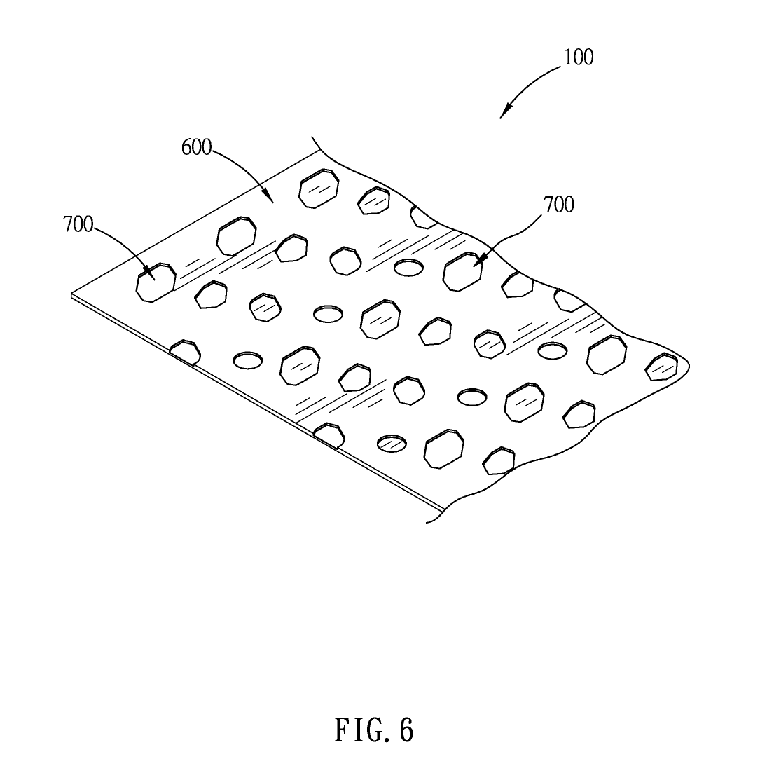

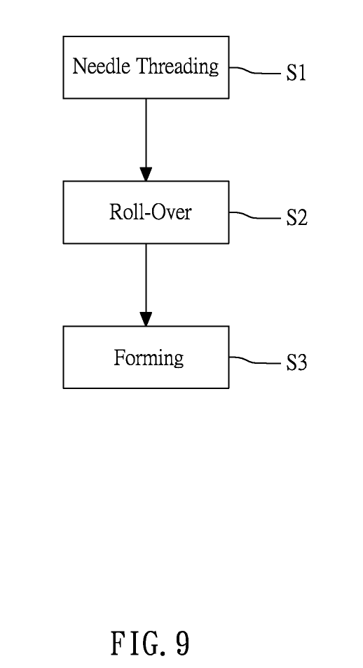

Please refer to FIGS. 3 to 6 and 9, the steps of the method for making the air permeable waterproof textile with the uneven pattern may comprise:
a needle threading step S1: transporting the fabric foundation 300 through the row needle set 200 with the transportation speed toward a transporting direction (direction A in FIG. 3), the threading holes 3 are formed after the fabric foundation 300 is threaded by the row needle set 200, the row needle set 200 is arranged above the fabric foundation 300 and spaced apart therefrom a distance D, the fabric foundation 300 at least includes a cloth carrier 1 and a waterproof film 2 made by soft plastic materials and melt adhered on a surface of the cloth carrier 1, the cloth carrier 1 is arranged adjacent to the row needle set 200 and the waterproof film 2 is arranged opposite to the row needle set 200, the burr portion 4 is extended from the waterproof film 2 downwardly corresponding to each threading hole 3, and a semi-finished product 400 is formed;
a roll-over step S2: transporting the semi-finished product 400 in the transporting direction (direction A in FIG. 3) and passing between an upper roller 500 and a lower roller 600 arranged below the upper roller 500 to be rolled over, and a predetermined pattern 700 is concavely formed on a surface of the lower roller 600, the lower roller 600 is heated to deform the waterproof film 2 so that the threading holes 3 are totally or partially shielded by corresponding burr portions 4 with different extent and then formed water proof and air permeability with different degree, and an uneven pattern 710 is formed on the fabric foundation 300 corresponding to the predetermined pattern 700; and
a forming step S3: cooling the semi-finished product 400 after the roll-over step S2 to form an air permeable waterproof textile 100 with the uneven pattern 710.

Therefore, according to above mentioned steps, the density of the arrangement of the threading holes 3 may be high or low by controlling the transportation speed of the fabric foundation 300. That is, the density of the threading holes 3 is high while the transportation speed is high, and the density of the threading holes 3 is low while the transportation speed is low. A vent-typed backing fabric is formed with a plurality of tiny through holes distributed densely and without removing chips. Partial or total burr portions 4 are rolled over by the upper roller 500 and the lower roller 600 with the predetermined pattern 700 so as to shield corresponding threading holes 3 with different extent. The threading holes 3 which are not shielded have total air permeability. The threading holes 3 which are partially shielded have partial air permeability with different percentages. The areas of the textile 100 without the threading holes 3 have water proof characteristics of the waterproof film 2. Therefore, the textile 100 may include air permeability, ware proof, and uneven patterns at the same time. It may be simplified materials, easy process, less material waste, cost down, and increasing yield rate.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A method for making an air permeable and waterproof textile with an uneven pattern, the steps comprising:
a needle threading step: transporting a fabric foundation through a row needle set with a transportation speed toward a transporting direction, a plurality of threading holes are formed after the fabric foundation is threaded by the row needle set, the row needle set is arranged above the fabric foundation and spaced apart therefrom a distance, the fabric foundation at least includes a cloth carrier and a waterproof film made by soft plastic materials and melt adhered on a surface of the cloth carrier, the cloth carrier is arranged adjacent to the row needle set and the waterproof film is arranged opposite to the row needle set, a burr portion is extended from the waterproof film downwardly corresponding to each threading hole, and a semi-finished product is formed;
a roll-over step: transporting the semi-finished product in the transporting direction and passing between an upper roller and a lower roller arranged below the upper roller to be rolled over, and a predetermined pattern is concavely formed on a surface of the lower roller, the lower roller is heated to deform the waterproof film so that the threading holes are totally or partially shielded by corresponding burr portions with different extent and then formed water proof and air permeability with different degree, and an uneven pattern is formed on the fabric foundation corresponding to the predetermined pattern; and
a forming step: cooling the semi-finished product after the roll-over step to form an air permeable waterproof textile with the uneven pattern.

2. The method as claimed in claim 1, wherein another cloth carrier is melt adhered on a bottom surface of the waterproof film.
